(19) United States
(12) Patent Application Publication
(10) Pub. No.: US 2025/0350680 A1
(43) Pub. Date: Nov. 13, 2025

(54) SYSTEM AND METHOD FOR ALLOWANCE OF POSSESSION OF CELL PHONES IN A GATHERING

(71) Applicant: JOHN F. LEONARD, Haddonfield, NJ (US)

(72) Inventor: JOHN F. LEONARD, Haddonfield, NJ (US)

(21) Appl. No.: 19/279,566

(22) Filed: Jul. 24, 2025

Related U.S. Application Data
(63) Continuation-in-part of application No. 19/052,926, filed on Feb. 13, 2025.
Application No. 19/052,926 is a continuation-in-part of application No. 17/895,698, filed on Aug. 25, 2022, now Pat. No. 12,256,037.
(60) Provisional application No. 63/393,328, filed on Jul. 29, 2022.

(51) Int. Cl. H04M 1/72463; H04W 4/021; H04W 48/04

(52) U.S. Cl. CPC H04M 1/72463; H04W 4/021; H04W 48/04

(57) ABSTRACT

A system and method for improved aspects of cell phone possession and use, including automotive safety, particularly aimed at the prevention of automobile, truck, and other vehicle accidents related to driving in a distracted manner while using a cell phone, and use and possession of cell phones in gatherings, such as in schools, churches, synagogues, movie theatres, symphony and opera halls, outdoor rock concerts, and restaurants in a manner acceptable to the administration of such spaces and in a polite, civil, and respectful manner toward other persons gathered in such spaces.

### CROSS REFERENCE TO RELATED APPLICATION

This application is a continuation-in-part of U.S. application Ser. No. 19/052,926 filed on Feb. 13, 2025 which application was a continuation-in-part of U.S. application Ser. No. 17/895,698 filed on Aug. 25, 2022 that claimed the benefit of U.S. Provisional Application 63/393,328 filed on Jul. 29, 2022.

### FIELD OF THE INVENTION

The general field of the instant invention is technology for the improvement of automotive safety, particularly with respect to the use by drivers distracted by their use of cell phones while driving. Additionally, this invention contemplates the migration of technology that controls cell phone usage to other areas, such as use of cell phones in school by students and disturbance and annoyance to others as a result of the use of cell phones in gatherings in certain venues.

### BACKGROUND OF THE INVENTION

Texting while driving is well known to cause automotive accidents, many of which end in death. For example, it has been reported that 14% of fatal car crashes involve cell phones. In 2018, over 400,000 people were injured and over 2,800 people died in distracted driving motor vehicle accidents. Tellingly, a full 42% of high school students admitted in 2015 that they text or e-mail during driving, and statistics say that cell phone usage reduces a driver's attention by as much as 37% (as reported by Children's Hospital of Philadelphia Research Institute). For these statistics and other examples, see: https://www.thezebra.com/resources/research/texting-and-driving-statistics/

While law enforcement measures have been implemented in order to stem the crisis of distracted driving, the crisis continues unabated.

Additionally, the ubiquitous use of cell phones has manifested many changes in regular life situations, other than driving in the car. Many states and municipalities have initiated programs or drafted legislation intended to restrict the use of cell phones by students in public school rooms during the school day. See, e.g., https://www.newsobserver.com/news/politics-government/article309332645.html. These programs in the main rely on voluntary participation of students or on the ability of teachers to enforce restrictions, which enforcement, of course, distracts teachers from the more important task of instruction in the classroom. For this reason, the instant invention provides a way for school administrators to ensure compliance with restrictions on use of cell phones by students in the classroom. Additionally, policies that require cell phones to be stored outside of the classroom are subject to concerns of theft, loss, breakage, and mistaken ownership, to say nothing of the loss of usefulness and value in having students retain access to their cell phones should an emergency situation arise in the school. This invention solves both of those problems by allowing students to keep their cell phones on their persons in the classroom, given that control of certain functionality of such devices is vested in the administration of the school, which functionalities can be turned on and off remotely. Hence, in an emergency situation under the instant invention, function-restricted phones can be remotely reactivated to send and receive calls, for example, from and to parents.

Moreover, an annoyance of modern life related to the ubiquitous use of cell phones is the particular form of noise pollution and disturbance in the gatherings of people caused by the random, sometimes incessant, ringing of phones for incoming calls especially in interior spaces, such as without limitation in churches, synagogues, and restaurants. Perhaps even more importantly, other persons in a gathering are often subjected to unwanted, loud, audible phone conversations indulged in by self-possessed individuals, especially in theatres or at the opera, or even in crowds in more open spaces, such as outdoor concerts. For example, some artists, such as Jack White of The White Stripes and The Raconteurs, have barred cell phones at concerts by collecting phones before entry. Other performers are considering banning cell phones, such as Sabrina Carpenter. See, e.g., https://www.rollingstone.com/music/music-news/jack-white-talks-banning-phones-at-concerts-with-metallicas-lars-ulrich-204906/; https://nypost.com/2025/06/19/entertainment/sabrina-carpenter-may-start-banning-phones-at-her-concerts/. One embodiment of the instant invention described herein is intended to restrict if not eliminate such noise pollution and disturbance without the need to collect and store phones on entry to a venue, which collection and storage can expose cell phones to loss, whether by theft or mistake, and further such collection does not allow for the use of phones by participants in a gathering with immediacy in case of an emergency. This solution of this embodiment is particularly apropos to the situation posed in connection with entry into concert venues, whether indoors in an opera house, a symphony hall, or a popular music soundstage, or outdoors for a rock concert in a stadium, because entry into such venues in present day presupposes the storing of tickets in memory of smartphones, rather than by hard copy tickets. Since potential entrants are required to show proof of entry by a digital representation on the screen of a cell phone, those phones required to be brought to the entrance of the venue to prove payment of the entrance fee are then part of the problem. The instant invention solves the problem of the self reflexive conundrum of requiring cell phones for entry and then banning them from entry.

### SUMMARY OF THE INVENTION

Presently, the technology available is not sufficient to cure the driving crisis stated above, much less to prevent individual cases of distracted driving. In addition to the law enforcement efforts stated above, while some vehicles do not allow the operator to enter navigation requests on the dashboard during driving, the technology as it currently exists does not prevent a driver from distracted driving while using his or her cell phone versus using the hands-free feature. As another example of such limited technology, the program known as Android Auto acts simply to bring apps from a cell phone to the car display so that “you can focus while you drive.” Android promises the driver that “you can control features like navigation, maps, calls, text messages, and music.” Not only is using Android Auto solely a voluntary choice by a driver, moreover the program requires a potential user to obtain information about that driver's car's compatibility with Android Auto by contacting the vehicle manufacturer. See generally: https://www.android.com/auto/?gclid=Cj0KCQjwz96WBhC8ARIsAATR253-jtig-ja YbZkRHL4ibFQzbib_cwWQ2HzKe-pHjvPFeeTPI8vSYSaAl14EALw_wcB&gclsrc=aw.ds

As described herein, the instant invention, once installed, does not provide a driver with a voluntary choice to drive undistracted; rather, the instant invention, once installed, prevents a driver from accessing any application programs on a cell phone while driving, as described in a preferred embodiment hereinbelow.

Similarly, the invention in another embodiment provides for a system and method to control the use of cell phones in a school setting by students retaining phones in a classroom as well as to prevent the disturbance created by the indiscriminate use of cell phones in any gathering of people, whether indoors in a church, restaurant, symphony, or opera halls, or outdoors at a rock concert.

### BRIEF DESCRIPTION OF THE DRAWING

FIG. 1 is a flowchart of the application program that enables the method of the preferred embodiment of the present invention.

FIG. 2 is a block diagram of the system of the preferred embodiment of the present invention.

FIG. 3 is a block diagram of the system of an embodiment of the present invention.

FIG. 4 is a block diagram of the system of another embodiment of the present invention.

FIG. 5 is a flowchart of the application programs that describes the method of said other embodiment of the present invention.

FIG. 6 is a block diagram of the system of a third embodiment of the present invention.

FIG. 7 is a flowchart of the application programs that describes the method of said third embodiment of the present invention.

### DETAILED DESCRIPTION OF THE INVENTION

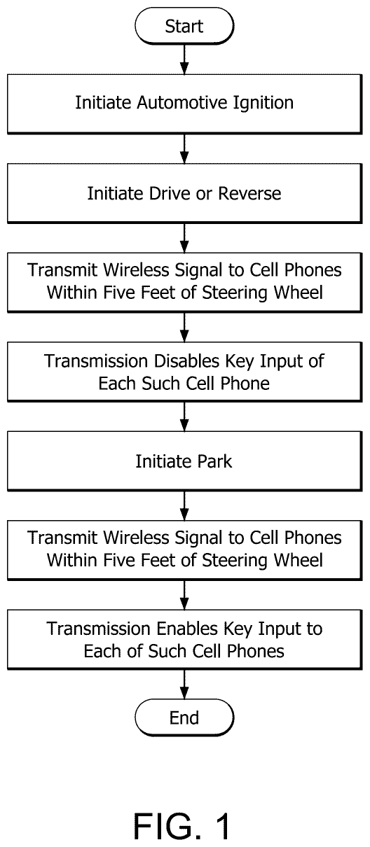

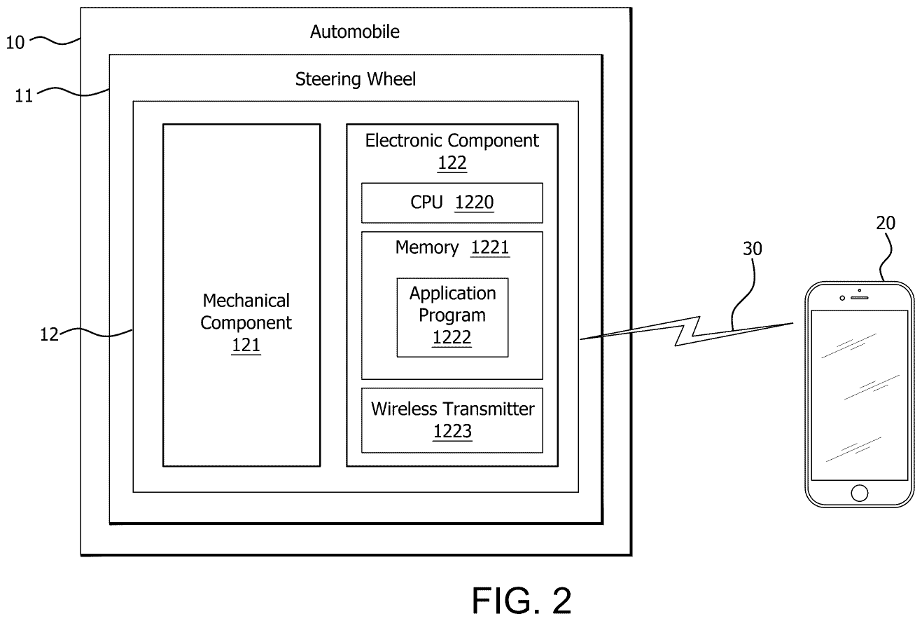

Referring to the drawings filed herewith, the flowchart of FIG. 1 sets forth the steps of the software application program 1222 of the instant invention that is shown in the block diagram of the hardware of the preferred embodiment of the disclosed system. FIG. 2 shows an automobile, truck, or bus 10, having a steering wheel 11 in which is constructed an electromechanical device 12, having a mechanical component 121 that identifies movement of vehicle 10, such as an accelerometer, and an electronic component 122 comprised of a CPU 1220, a wireless receiver/transmitter 1223, and a memory 1221 in which is stored an application program 1222. Additionally, FIG. 2 shows a cell phone 20 located within five feet of steering wheel 11 within said vehicle 10, said cell phone being in communication with said electrical component 122 through wireless connection 30. Said communication 30 can be, for example, a Bluetooth wireless link, but this is not a limitation on the breadth to be afforded this invention.

As per the flowchart of FIG. 1, when a driver starts up his or her vehicle, the mechanical component 121 of electromechanical device 12 senses motion of vehicle 10. Mechanical component 121 is outfitted to send an electronic signal to electronic component 122, which signal triggers CPU 1220 to initiate application program 1222 resident in memory 1221 of said electronic component 122. Said application program 1222 causes CPU 1220 to cause wireless transmitter 1223 to send a disabling signal via wireless link 30 to each cell phone 20 located within 5 feet of said steering wheel 11. As said flowchart shows, once PARK is initiated by the driver of vehicle 10 and mechanical component 121 senses a cessation of movement, an electronic signal is sent from said mechanical component 121 to electronic component 122, causing CPU 1220 in coordination with application program 1222 to send a wireless signal via wireless connection 30 to each cell phone 20 within five feet of steering wheel 11 canceling the disabling signal that was previously sent to each such cell phone 20, allowing the handheld use of said cell phones 20 once again.

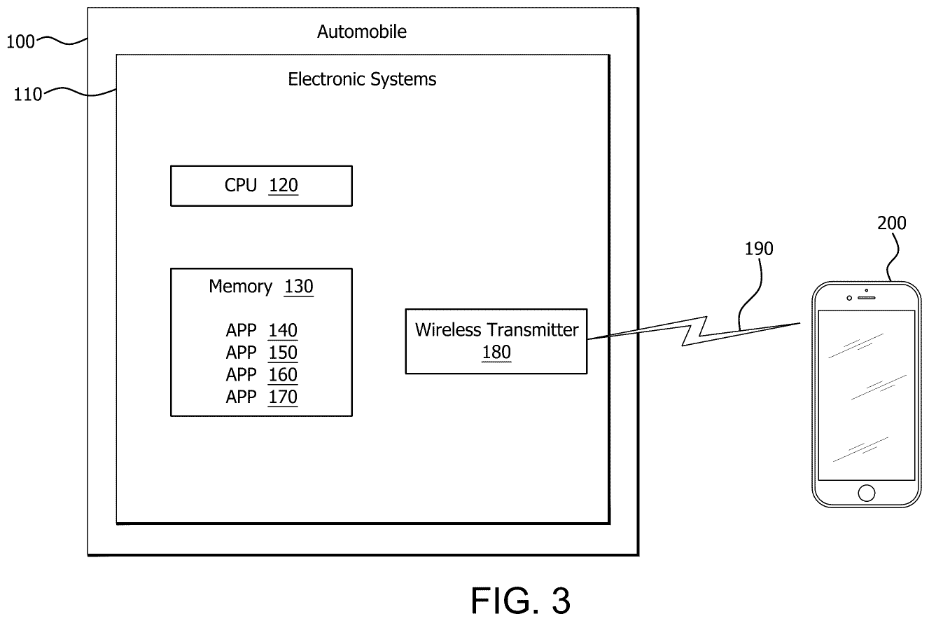

FIG. 3 shows another embodiment of the instant invention, that is, an automobile, truck, or bus 100, having built-in electronic systems 110 that are comprised of a CPU 120, a wireless transmitter 180, and memory 130 in which are stored a panoply of application programs (“apps”), including app 140, app 150, app 160, and app 170, the later being an application designed to prevent distracted driving. FIG. 3 shows a cell phone 200 located within said vehicle 100, said cell phone having stored therein a resident application program compatible with and in communication with said app 170 through wireless connection 190, said application program having control over certain functions of said cell phone 200. Said communication 190 can be, for example, a Bluetooth wireless link, but this is not a limitation on the breadth to be afforded this invention.

In this embodiment of the instant invention, after a driver initiates automotive ignition in vehicle 100 and then initiates drive mode or reverse mode of said vehicle 100, app 170 in said vehicle 100 electronic system 110 receives an electronic signal identifying the initiation of one of said modes, which signal is generated by CPU 120 under the control of app 140 stored in memory 130. Said CPU 120 under the control of said app 170 causes wireless transmitter 180 to send a disabling signal via wireless link 190 to said compatible application program resident in cell phone 200. Once the park mode is initiated by said driver of said vehicle 100, an electronic signal identifying such mode initiation causes CPU 120 under the control of app 170 to send a wireless signal via wireless connection 190 to said compatible application program stored in memory of said cell phone 200 canceling the disabling signal that was previously sent to each such cell phone 200, allowing the handheld use of the key input of said cell phone 200 once again.

App 170 in another embodiment is programmed to generate a disabling signal that is sent by wireless transmitter 180 to a second app in said cell phone 200 that controls the disabling of the screen display of cell phone 200 as well as controlling the disabling of the key input of said cell phone 200. In a third embodiment, app 170 is programmed to generate a disabling signal that is sent by the wireless transmitter 180 to said second app in said cell phone 200 that controls the disabling of the touch screen of said cell phone 200.

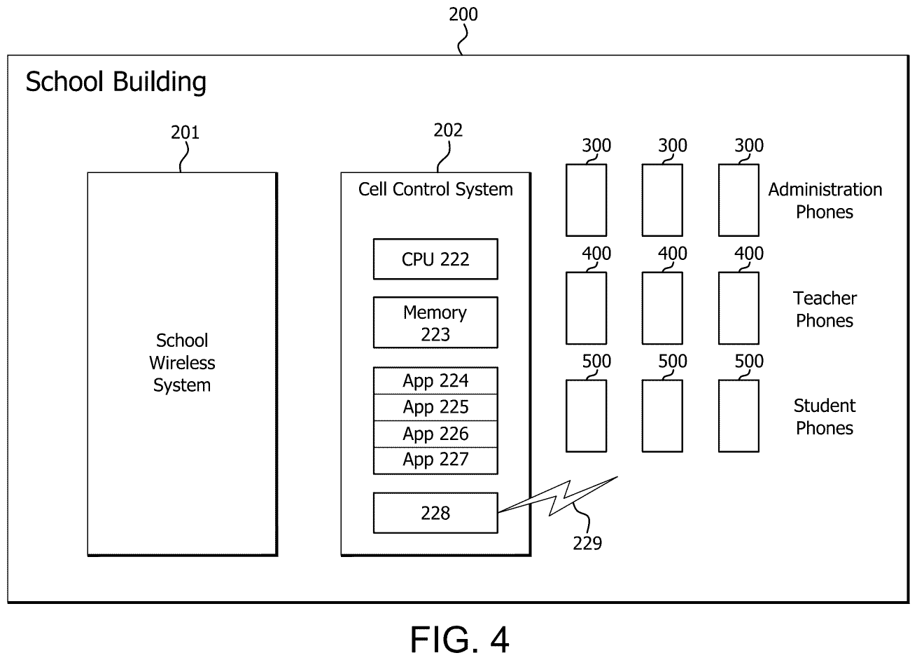

FIG. 4 shows an embodiment of the instant invention, that is, use of the disclosed system in a school building 200 having a resident wireless system 201. Located in such school building 200 during school hours are located cell phones 300 in the control of and used by administrative and staff personnel, cell phones 400 in the control of and used by teachers and teaching assistants, and cell phones 500 in the control of and in normal circumstances used by students. In this embodiment of the instant invention, an electronic wireless cell control system 202 is located within such school building. System 202 is comprised of a CPU 222, a wireless transmitter 228, and memory 223 in which are stored a panoply of application programs (“apps”), including app 224, app 225, app 226, and app 227, being applications designed to control the use of cell phones located within school building 200. Such transmitter 228 under the control of said CPU 222 is programmed to transmit a wireless link 229 within school building 200. In order to be granted access into school building 200, each of such student cell phones 500 shall have stored therein application program 501 compatible with and in communication with said apps 224, 225, 226, and 227 through wireless transmitter 228, said application programs having control over certain functions of each of said cell phones 500 in communication with such app 501. Said communication link 229 can be, for example, a Bluetooth wireless link, but this is not a limitation on the breadth to be afforded this invention.

The installation of app 501 into the memory of any one student's cell phone can be accomplished in a number of ways. For example, an app 501 can be downloaded individually and voluntarily from the internet; the administration of school 200 can set up a program at the beginning of the school year to download app 501 into students' cell phones 500 in person and collectively; or a link to an app 501 can be sent by e-mail to the parents who desire that their student bring his or her cell phone to class, and that link can be used by said parents for downloading app 501 at home. In each case, the administration will desire to ensure that each cell phone 500 of a student that is intended to be brought into a classroom has app 501 resident therein. This may be accomplished in a variety of ways, for example, by detection electronically at the door of the school 200 or by visual inspection.

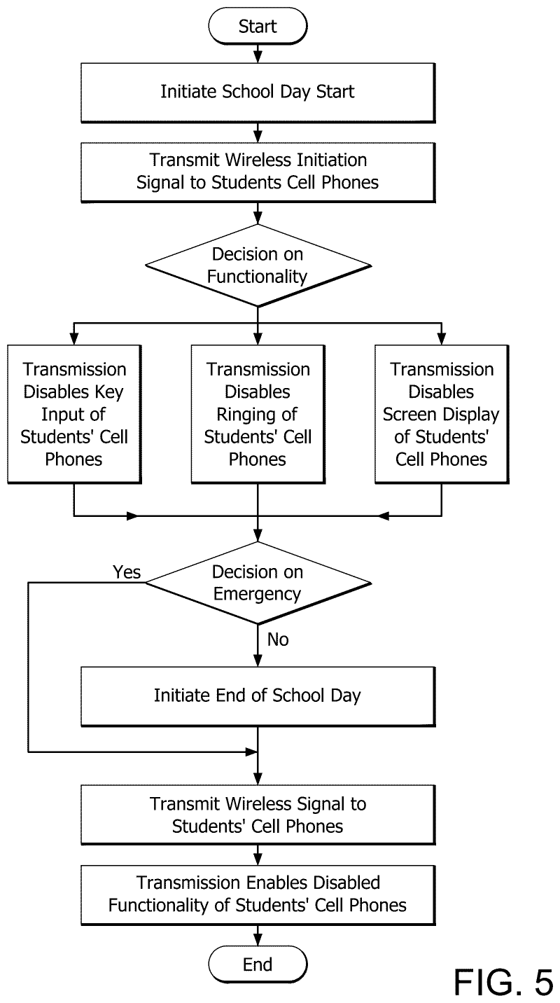

The method of this embodiment of the instant invention is shown in the flowchart set forth in FIG. 5. At the time that the school day commences, app 227 is initiated by school 200 administration which app transmits an initiation signal 229 to each student cell phone 500, such signal identifying the initiation of the school day, which signal is generated by transmitter 228 as controlled by CPU 222 in conjunction with app 224 stored in memory 223 of system 202. Said app 227 causes wireless transmitter 228 to send a disabling signal via wireless link 229 to each of said compatible application program 501 resident in said cell phones 500 which disabling signal prevents the audible ringing of each of said cell phones 500. In normal operation under this embodiment, once such administration determines the end of the school day, an electronic signal identifying such end causes CPU 222 in conjunction with app 224 to send a wireless signal via wireless connection 229 to said compatible application programs 501 stored in memory of each of said cell phones, such signal reenabling the ringing functionality of each of such cell phones 500. It should be understood that FIG. 5 is not intended to cover every aspect of the current invention including the functionalities of cell phones sought to be controlled or disabled.

Said app 224 may be programmed to operate in conjunction with apps 225, 226, and 227 to generate a panoply of certain additional disabling signals in addition to said disabling of audible ringing of said cell phones 500 to be sent by wireless transmitter 228 to compatible app 501 resident in each of said cell phones 500 that controls, for example, with app 225, the disabling of the screen display of said cell phones 500, or, for example, with app 226, controlling the disabling of the key input of each of said cell phones 500. In this embodiment, app 224 may be programmed in conjunction with app 227 to generate a disabling signal that is sent by the wireless transmitter 229 to said compatible app 501 in each of said cell phones 500 controlling the disabling of the touch screens of each of said cell phones 500. App 224 can be controlled by said administration to reenable any of such certain functionality of said cell phones 500 at any time and from time to time. The disabling of certain functionality of cell phones that continue to be in the possession of students in the classroom is especially well suited to preventive measures designed to prohibit the use of access to information or programs on the internet, such as, without limitation, wiki websites or artificial intelligence programs, by students during examinations or other activities in the classroom.

In another embodiment, the system and method described above for school use is similarly useful to ameliorate the problem of noise pollution in gatherings taking place in indoor spaces such as, without limitation, churches, synagogues, theatres, movie theatres, opera houses, symphony halls, and restaurants, in which spaces the audible ringing of cell phones is a distraction to and provokes aggravation in other persons. In this way, the system and method described herein fosters a polite and respectful manner as to other participants and invitees gathered in such spaces. For example, and without limitation, an app such as app 224 of FIG. 4 can be configured to disable the audible ringing of cell phones controlled by worshippers or patrons in such spaces without the need for a compatible app, such as app 501 in the school embodiment, to be resident in each of such cell phones. Similarly, an app such as app 224 in the school example may be used to disable the microphone input of such cell phones to ameliorate the annoyance caused by audible conversations carried on by such cell phone users in such spaces. Other functions of a cell phone that may be desired to be controlled in a school environment or in a venue in which gatherings take place and that can be disabled by way of the instant invention include, but are not limited to, key input functionality; touch screen functionality; camera functionality; audible sound functionality; sound recording functionality; flashlight functionality; and display screen functionality. The disabling of sound recording functionality, audible sound transmission functionality, camera or video functionality, and flashlight functionality are especially desirable to create a civil atmosphere in concert venues whether indoors or outdoors.

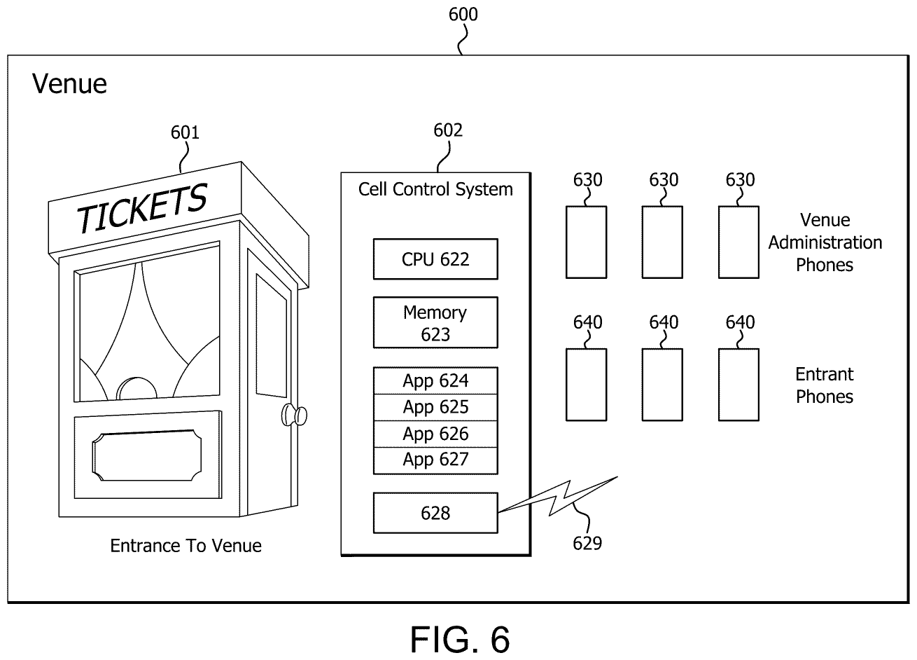

In this vein, FIG. 6 shows an embodiment of the instant invention, that is, use of the system of the instant invention in a venue 600. Said venue 600 can be, but is not limited to, a church, a synagogue, a restaurant, a theatre, a movie theatre, an opera house, a symphony hall, an indoor concert venue, or an outdoor concert venue. Located in such venue 600 are cell phones 630 in the control of and used by administrative and staff personnel for the venue as well as cell phones 640 in the control of and used by entrants after their entrance into said venue 600. In this embodiment of the instant invention, an electronic wireless cell control system 602 is located within such venue 600. System 602 is comprised of a CPU 622, a wireless transmitter 628, and memory 623 in which are stored a panoply of application programs (“apps”), including app 624, app 625, app 626, and app 627, being applications designed to control the use of cell phones after entrance into venue 600. Such transmitter 628 under the control of said CPU 622 is programmed to transmit a wireless link 629 that reached all boundaries of venue 600. In order to be granted access into venue 600, each potential entrant will need evidence proof of entry, such as, without limitation, an digital ticket programmed to appear on the display of each of said cell phones 640. In one embodiment, such cell phones 640 shall have stored therein along with such digital ticket an application program 6000 compatible with and in communication with said apps 624, 625, 626, and 627 through wireless transmitter 628, said application programs having control over certain functions of each of said cell phones 640 in communication with such app 6000. Said communication link 629 can be, for example, a Bluetooth wireless link, but this is not a limitation on the breadth to be afforded this invention.

In one embodiment the installation of app 6000 into the memory of any one entrants' cell phones 640 can be accomplished in a number of ways. For example, an app 6000 can be downloaded individually and voluntarily from the internet at the same time that said digital ticket is downloaded. In another embodiment, an application program 6000 is not required to be downloaded in said cell phones 640. Confirmation of the residency of application program 6000, when required, may be accomplished by detection electronically at the door of said venue 600 or by visual inspection of said cell phones 640 by staff at the entrance to venue 601.

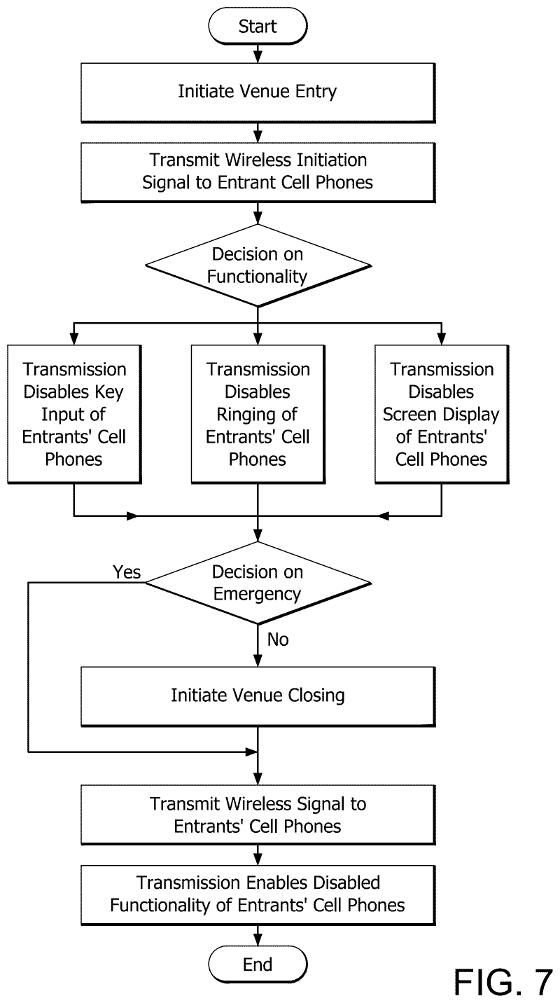

The method of this embodiment of the instant invention is shown in the flowchart set forth in FIG. 7. At the time that venue 600 is opened for arrival of entrants, app 627 is initiated by venue 600 administration which app continuously transmits an initiation signal 629 to each entrant cell phone 640 at arrival, such signal identifying the initiation of venue entry, which signal is generated by transmitter 628 as controlled by CPU 622 in conjunction with app 624 stored in memory 623 of system 602. Said app 627 causes wireless transmitter 628 to send a disabling signal via wireless link 629 to each of said cell phones 640, or in one embodiment to said compatible application program 6000 resident in said cell phones 640 which disabling signal prevents the audible ringing of each of said cell phones 640 while said entrants remain within the boundaries of said venue 600. In normal operation under this embodiment, once such venue 600 administration determines venue closing, an electronic signal identifying such closing causes CPU 622 in conjunction with app 624 to send a wireless signal via wireless connection 629 to each of said cell phones 640, or to said compatible application programs 6000 stored in memory of each of said cell phones 640, such signal reenabling the ringing functionality of each of such cell phones 640. It should be understood that FIG. 7 is not intended to cover every aspect of the current invention including the functionalities of cell phones sought to be controlled or disabled within the boundaries of said venue 600.

Said app 624 may be programmed to operate in conjunction with apps 625, 626, and 627 to generate a panoply of certain additional disabling signals in addition to said disabling of audible ringing of said cell phones 640 to be sent by wireless transmitter 628 to compatible app 6000 resident in each of said cell phones 640 that controls, for example, with app 625, the disabling of the screen display of said cell phones 640, or, for example, with app 626, controlling the disabling of the key input of each of said cell phones 640. In this embodiment, app 624 may be programmed in conjunction with app 627 to generate a disabling signal that is sent by the wireless transmitter 629 to said compatible app 6000 in each of said cell phones 640 controlling the disabling of the touch screens of each of said cell phones 640. App 624 can be controlled by said venue administration to reenable any of such certain functionality of said cell phones 640 at any time and from time to time. The disabling of certain functionality of cell phones that continue to be in the possession of entrants while in the confines of venue 600 is especially well suited to preventive measures designed to prohibit the use of, for example, the flashlight function of said cell phones 640, which flashlights can be distracting to performers in a concert venue, or the use of camera functionality of said cell phones 640, which is critical to preventing the video recording of concerts which recording is not acceptable to certain performers at said venue 600.

In another embodiment, the system and method described are useful to ameliorate the problem of noise pollution in indoor spaces such as, without limitation, churches, synagogues, theatres, movie theatres, opera houses, symphony halls, and restaurants, in which spaces the audible ringing of cell phones is a distraction to and provokes aggravation in other persons. In this way, the system and method described herein fosters a polite and respectful manner as to other participants and invitees in such spaces. For example, and without limitation, an app such as app 624 of FIG. 6 can be configured to disable the audible ringing of cell phones controlled by worshippers or patrons in such spaces without the need for a compatible app, such as app 6000 to be resident in each of such cell phones 640. Similarly, an app such as app 624 may be used to disable the microphone input of such cell phones to ameliorate the annoyance caused by audible conversations carried on by such cell phone users in such spaces. Other functions of a cell phone that may be desired to be controlled in a venue 600 may include, but are not limited to, key input functionality; touch screen functionality; camera functionality; audible sound functionality; sound recording functionality; flashlight functionality; and display screen functionality. The disabling of sound recording functionality, audible sound transmission functionality, camera or video functionality, and flashlight functionality are especially desirable to create a civil atmosphere in rock concert venues whether indoors or outdoors.

While the instant invention provides a solution for students to retain possession of cell phones in school while ensuring that the negative aspects of such cell phone possession and use in the classroom are ameliorated, it should be appreciated that the scope of the instant invention is not intended to be limited to certain electronic devices, hardware, or programming that may be specified herein; rather, it is intended that the scope of the instant invention be viewed in the most broad manner and with application to situations not limited to grade school or high school applications. Similarly, the sister solution described herein that provides a system and method for limiting noise pollution, such as, without limitation, the negative effect of cell phone ringing in closed areas as well as the aggravating use of cell phones in such areas or those areas not enclosed is not intended to be limited in scope, for example, to system components or software, or to the areas of specific concern discussed herein. Each embodiment of the instant invention is intended to be viewed and should be viewed from the broadest perspective; named apparatuses, devices, and technology are not intended to limit the breadth of the disclosure, but rather are intended to include apparatuses, devices, and technology not yet developed.

What is claimed:

1. A system for allowing the possession of cell phones by persons gathering in a venue and controlling the functionality of such cell phones in such venue comprising:
a central processing unit;
a memory;
a first application program stored in such memory; and
a wireless transmitter;
whereby said system transmits a wireless signal to each of such cell phones at the time of entry of a person possessing such a cell phone into such gathering which signal disables the ringing functionality of such cell phones.

2. The system of claim 1 in which certain functionality of such cell phones other than such ringing functionality is disabled by such signal wherein such certain functionality is selected from the group comprising: microphone functionality; key input functionality; touch screen functionality; camera functionality; audible sound transmission functionality; sound recording functionality; flashlight functionality; access to the internet functionality; and display screen functionality.

3. The system of claim 1 in which such wireless signal is a Bluetooth signal.

4. The system of claim 1 in which such venue is selected from the group comprising: a school; a church; a synagogue; a restaurant; a theatre; a movie theatre; an opera house; a symphony hall; an indoor concert venue; or an outdoor concert venue.

5. The system of claim 1 in which such venue is a school and such persons are students of such school further comprising: a second application program stored in memory of such cell phones compatible with such first application program, wherein said first application program transmits a wireless signal to such cell phone at the beginning of the school day which signal is compatible with and in communication with such second application program resident in memory of such cell phones and which second application program controls the disabling of certain functionality of such cell phones.

6. The system of claim 5 in which such functionality is selected from the group comprising: ringing functionality; microphone functionality; key input functionality; touch screen functionality; camera functionality; audible sound transmission functionality; sound recording functionality; access to the internet functionality; and display screen functionality.

7. The system of claim 5 in which such wireless signal is a Bluetooth signal.

8. A method for allowing the possession of cell phones by students in a school and controlling the functionality of such cell phones comprising the steps of:
initiating school day start;
a first application program resident in memory of an electronic system in such school sending a first signal to a wireless transmitter resident in such system;
such first signal causing said transmitter to transmit a first wireless signal to a wireless receiver resident in such cell phones;
such wireless receiver sending a second signal to a second application program resident in such cell phones;
such second application program processing such second signal; and
such second application program controlling the central processing unit of such cell phones by sending a third signal disabling certain functionality of such cell phones;
whereby students are allowed to maintain possession of such cell phones in school with certain functionality of such cell phones being disabled and whereby administrators and teachers remain able to maintain possession of cell phones that are fully functional in school simultaneously.

9. The method of claim 8 in which such certain functionality of such cell phones disabled by such second application program is selected from the group comprising: ringing functionality; microphone functionality; key input functionality; touch screen functionality; camera functionality; audible sound transmission functionality; sound recording functionality; access to the internet functionality; and display screen functionality.

10. The method of claim 8 in which such wireless signal is a Bluetooth signal.

11. The method of claim 8 further comprising the steps of:
deciding whether such school is in an emergency situation;
in the case in which a decision is made that an emergency situation exists, such first application program sending a second signal to such wireless transmitter;
such second signal causing such transmitter to transmit a second wireless signal to a wireless receiver resident in such cell phones;
such wireless receiver sending a third signal to such second application program;
such second application program processing such third signal; and
such second application program controlling the central processing unit of such cell phones by sending a fourth signal enabling all functionality of such cell phones;
whereby all functionality of such cell phones is restored for use by students during an emergency.

12. The method of claim 11 further comprising the steps of:
deciding whether such school remains in an emergency situation;
in the case in which a decision is made that an emergency situation no longer exists, reinitiating school day start;
a first application program resident in memory of an electronic system in such school sending a first signal to a wireless transmitter resident in such system;
such first signal causing said transmitter to transmit a first wireless signal to a wireless receiver resident in such cell phones;
such wireless receiver sending a second signal to a second application program resident in such cell phones;
such second application program processing such second signal; and
such second application program controlling the central processing unit of such cell phones by sending a third signal disabling certain functionality of such cell phones;
whereby students are again allowed to maintain possession of such cell phones in school with certain functionality of such cell phones being disabled and whereby administrators and teachers remain able to maintain possession of cell phones that are fully functional in school simultaneously.

13. The method of claim 12 further comprising the steps of:
initiating end of school day.
such first application program sending a second signal to such wireless transmitter;
such second signal causing such transmitter to transmit a second wireless signal to a wireless receiver resident in such cell phones;
such wireless receiver sending a third signal to such second application program;
such second application program processing such third signal; and
such second application program controlling the central processing unit of such cell phones by sending a fourth signal enabling all functionality of such cell phones;
whereby all functionality of such cell phones is restored for use by students at the end of the school day.

14. A method for allowing the possession of cell phones by persons in a gathering and controlling the functionality of such cell phones comprising the steps of:
initiating gathering start;
a first application program resident in memory of an electronic system sending a first signal to a wireless transmitter resident in such system;
such first signal causing said transmitter to transmit a first wireless signal to a wireless receiver resident in such cell phones;
such wireless receiver sending a second signal disabling certain functionality of such cell phones;
whereby such persons are allowed to maintain possession of such cell phones in such gathering with certain functionality of such cell phones being disabled.

15. The method of claim 14 in which such functionality is selected from the group comprising: ringing functionality; microphone functionality; key input functionality; touch screen functionality; camera functionality; audible sound transmission functionality; sound recording functionality; flashlight functionality;
access to the internet functionality; and display screen functionality.

16. The method of claim 14 in which such gathering is selected from the group comprising: a school; a church; a synagogue; a restaurant; a theatre; a movie theatre; an opera house; a symphony hall; an indoor concert; or an outdoor concert.

17. The method of claim 14 further comprising the steps of:
initiating gathering end;
such first application program sending a second signal to such wireless transmitter;
such second signal causing such transmitter to transmit a fourth wireless signal to a wireless receiver resident in such cell phones; and
such fourth signal enabling all functionality of such cell phones;
whereby all functionality of such cell phones is restored for use by persons at the end of such gathering.

18. The method of claim 17 in which such functionality is selected from the group comprising: ringing functionality; microphone functionality; key input functionality; touch screen functionality; camera functionality; audible sound transmission functionality; sound recording functionality; flashlight functionality; access to the internet functionality; and display screen functionality.

19. The method of claim 17 in which such gathering is selected from the group comprising: a school; a church; a synagogue; a restaurant; a theatre; a movie theatre; an opera house; a symphony hall; an indoor concert; or an outdoor concert.
